(19) United States
(12) Patent Application Publication
(10) Pub. No.: US 2006/0207377 A1
(43) Pub. Date: Sep. 21, 2006

(54) Actuating device, particularly for an articulated arm

(76) Inventors: Florian Gosselin, Vanves (FR); Dominique Ponsort, Bievres (FR)

Correspondence Address: Thelen Reid & Priest, PO Box 640640, San Jose, CA, 95164-0640, US

(21) Appl. No.: 10/551,984

(22) PCT Filed: Apr. 1, 2004
(86) PCT No.: PCT/FR04/50138

§ 371 Date: Oct. 4, 2005

(30) Foreign Application Priority Data
Apr. 4, 2003 (FR) 0304200

(51) Int. Cl. B25J 18/00

(52) U.S. Cl. 74/490.01

(57) ABSTRACT

A control or robot articulated arm comprising motorised articulations, at least some of which are remote controlled by motors (15, 16) place on a base (3) to lighten the arm. The motors (15 and 16) are side by side and control coaxial pulleys (12 and 13) due to bulges (24, 25) at stages on the motor shafts (17 and 18). This reduces the overall size. FIG. 2.

### DESCRIPTION

The subject of this invention is an actuation arrangement, particularly for an articulated arm.

More precisely, it relates to movement transmission pulleys for a pair of motors controlling corresponding degrees of freedom in the arm.

In general, articulations or other degrees of freedom of the arm need to be motor controlled, joining segments to each other and to the base, to stop the arm at a stable position between two displacements or to control the displacements in the case of a slave arm. One simple concept for achieving this is to control the articulations directly by motors coaxial with the articulations; but there are problems with this, since the motors apply a large tilting moment on the arm due to their own self weight, and the motors have to balance this moment themselves. This creates a conflict between the need to reduce the weight of the motors and the need to make them powerful enough and therefore fairly heavy, and this conflict may be difficult for the arm designer to solve. The arm structure itself has to be fairly strong.

This is why attempts are often made to move the motors towards locations of the arm closer to the base or on the base itself. The tilting moments that they apply to the arm are then lower. Transmissions are added between the motors and the degrees of freedom that they resist. Although they complicate the arm, they remain lightweight enough so that they do not cancel out the reduction in weight possible due to the good position of the motors.

In one particular design, two motors are placed on a first part free to move with respect to the base, and from which the segment train articulated to the base begins. One typically controls the second segment of the train articulated to the first through its end opposite to the base. The other motor controls the third segment of the train articulated to the second. The position of the end of the third segment in space can be controlled by using a parallelogram type configuration on these two segments, and by using a motor to control the movement of the first segment with respect to the base.

Motor output shafts move together with pulleys forming part of transmissions leading to the articulations concerned and that considerably reduce the rotation movement of the motors. The pulleys are very advantageously coaxial and at the side of each other, so that they can be mounted on the same axis and the arm can thus be simplified, while saving space on the base.

The two motors may be placed in opposite directions, each at the side of the pulley that it controls, but the layout comprising the two motors aligned in the direction of their output shafts corresponding to their main elongation, and the two pulleys, is very wide. In practice, it becomes unacceptable to repeat it for another portion of the articulated arm and particularly a second arm leading to the same wrist.

Another arrangement consists of placing the motors side by side, the output shafts facing the same direction, and controlling pulleys with different diameters. The width of the layout is reduced because it is approximately equal to the sum of the widths of a single motor and pulleys. However, the difference in the diameter of the pulleys is unfortunate because it complicates the design of the arm and its control.

The invention relates to an improvement to these prior tests to control or retain an articulated arm with a pair of motors mounted on a common part and placed side by side. It thus concerns an actuation device comprising at least two motors placed side by side on the same part, motor shafts facing the same direction, at least two pulleys at least essentially coaxial and actuated by the motors, characterised in that the pulleys are offset along the motor shafts and in that the motor shafts have portions that engage on the pulleys that are also offset.

It also concerns an articulated arm on which this device is fitted and comprising a base, a train of segments and links between the segments and the base, and corresponding link actuation devices, two of the said actuation devices including motors fixed side by side to the base, motor shafts along the same direction, at least essentially coaxial pulleys, and mechanical transmissions joining the pulleys to the links actuated by the said two actuation devices, characterized in that the motor shafts are supported by a reinforcement fixed to the base and the pulleys are offset along the motor shafts, and the motor shafts have portions that engage on the pulleys that are also offset; preferably, the pulleys are perfectly coaxial, motor shaft portions that engage on the pulleys consisting of bulges on the motor shafts, and the reinforcement is unique and comprises a pair of bearings, aligned perpendicular to the motor shafts and supporting the ends of the motor shafts.

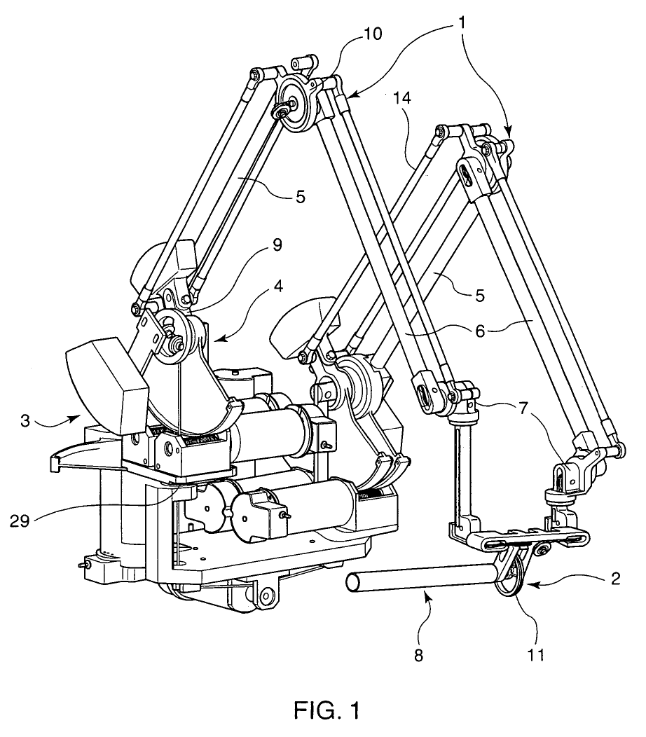

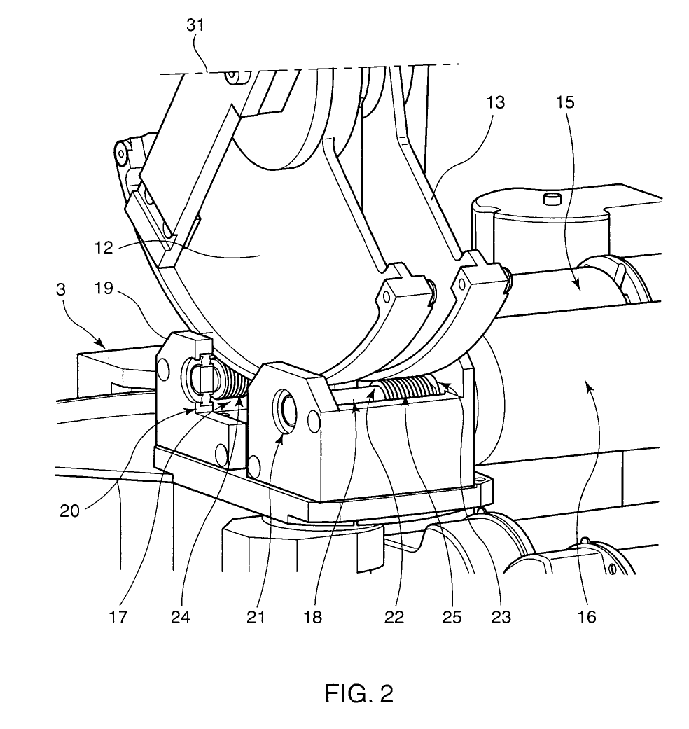

The invention will now be described with reference to the Figures, in which FIG. 1 represents a non-limitative overview of two arms equipped according to the invention, and FIG. 2 illustrates the invention itself.

A control arm is shown in FIG. 1. It comprises two branches 1 similar to each other and a wrist 2 that combines the ends of the branches 1 that are opposite to a fixed base (3). Each of the branches 1 is composed of a first vertical segment 4 pivoting about itself on the base 3, a second segment 5 articulated to the previous segment and capable of turning in a vertical plane, and a third segment 6 articulated to the previous segment also capable of turning in a vertical plane. A universal joint 7 connects the wrist 2 to the third segment 6, and the user grips a handle 8 belonging to the wrist 2. A translation movement applied to the wrist 8 displaces the segments 4, 5 and 6 in unison for the two branches 1, and tilting applied to the wrist displaces them with different movements of the two branches 1. Finally, the handle 8 can pivot about itself.

The arm comprises a first articulation 29 (not seen in FIG. 1) between the base 3 and the first segment 4, a second articulation 9 between the first and second segments 4 and 5, a third articulation 10 between the second and third segments 5 and 6, a triplet of articulations in joint 7, and finally a pivoting articulation 11 between the wrist 2 and the handle 8, for each of the branches 1. The first articulation 29 and the articulations 9, 10 and 11 are equipped with encoders to measure their movements and with a force return motor to retain them, which is conventional. On this arm, the invention is applicable to actuation of articulations 9 and 10 at the ends of the second segment 5 and to the elements functionally related to them. They are shown in FIGS. 1 and 2 and comprise a force return motor and a transmission including a pulley controlled by the motor, for each articulation in each branch 1.

The pulleys for each branch 1 are located on an axis 31 coincident with the axis of the second articulation 9. One of the pulleys is denoted reference 12 and directly controls rotation about axis 31, and the other of the pulleys is denoted reference 13 and controls rotation of the third segment 6 about the third articulation 10 through a connecting rod 14. The pulleys 12 and 13 are coaxial and have the same diameter. They are controlled by motors 15 and 16 respectively, each conventionally fitted with an encoder and comprising corresponding motor shafts or output shafts 17 and 18. The motors 15 and 16 are placed side by side and the motor shafts 17 and 18 are in the same direction. With reference particularly to the first Figure, it can be seen that the motors 15 and 16 are placed between the branches 1 and their pulleys 12 and 13, the motors of one of the branches 1 being vertically above the motors of the other of the branches 1: thus the distance between the two branches 1 remains moderate and the size of the base 3 is smaller in all directions because none of the motors 15 and 16 is directly in line with another motor in its long principal direction.

Segment 4 has a reinforcement 19 to support the motor shafts 17 and 18, particularly through bearings 20 and 21 located at the free ends of the motor shafts. The reinforcement 19 essentially surrounds the motor shafts 17 and 18 and in particular, apart from the end plates into which the bearings 20 and 21 fit, in particular comprises opposite end plates into which another bearing 22 or 23 fits for each of the shafts 17 and 18, and stringer walls joining these two end plates. The pulleys 12 and 13 pass between the end plates. Their outer tyres are perfectly side by side because they have the same diameter, but the motor shafts 17 and 18 have bulge portions 24 and 25 that are offset laterally, the first being close to the bearing 20 at the free end and the second being remote from it, and the motors 15 and 16 drive the pulleys 12 and 13 respectively with which they are associated by cable capstan type mechanisms themselves associated with the bulge portions 24 and 25 that form portions that engage without touching the other of the pulleys.

In this description, the two motors are located on the first mobile segment 4 and actuate the second and third articulations 9 and 10. This device is applicable to any other pair of articulations. The motors may be arranged on any other segment or fixed base, provided that the motors 15, 16 and the pulleys 12, 13 respect the general requirements illustrated in FIG. 2. In general, it is advantageous and recommended that the pulleys 12 and 13 should have the same radius, and that the portions that engage 24 and 25 should have the same radius, and that the two motors 15 and 16 and the transmissions as far as the rotation axes (in this case the axes of pulleys 12 and 13) should be identical. This simplifies the control.

The invention is also applicable to the case in which more than two pulleys are actuated by more than two motors, each comprising an output shaft with a bulge driving one of the parts by a cable capstan type mechanism.

It is applicable in all cases in which several mobile parts need to be actuated about the same axis or parallel axes, for example by the use of connecting rods.

1. Actuation device comprising at least two motors (15, 16) placed side by side on the same part (4), motor shafts (17, 18) facing the same direction, at least two pulleys (12, 13) at least essentially coaxial and actuated by the motors, characterised in that the pulleys (12, 13) are offset along the motor shafts and in that the motor shafts have portions that engage (24, 25) on the pulleys that are also offset.

2. Device according to claim 1, characterised in that the pulleys are perfectly coaxial, and the motor shaft portions that engage on the pulleys form bulges on the shafts.

3. Device according to claim 2, characterised in that the motor shafts are supported by a reinforcement (19) fixed to the part (4), that comprises a pair of bearings (20, 21) aligned with the motor shafts and supporting their free ends.

4. Articulated arm comprising a base (3), a train of segments (4, 5, 6) and links (9, 10) between the segments and the base, and corresponding link actuation devices, two of the said actuation devices (15, 16) including motors fixed side by side on a segment (4), motor shafts (17, 18) along the same direction, at least essentially coaxial pulleys (12, 13), and mechanical transmissions joining the pulleys to the links (9, 10) actuated by the said two actuation devices, characterized in that the motor shafts are supported by a reinforcement (19) fixed to the segment (4), the pulleys (12, 13) are offset along the motor shafts, and the motor shafts have portions (24, 25) that engage on the pulleys that are also offset.

5. Articulated arm according to claim 4, characterised in that the pulleys are perfectly coaxial, motor shaft portions that engage on the pulleys forms bulges on the motor shafts, and the reinforcement comprises a pair of bearings (20, 21), aligned with the motor shafts, supporting the motor shaft free ends.
